(19) United States
(12) Patent Application Publication
(10) Pub. No.: US 2012/0131323 A1
(43) Pub. Date: May 24, 2012

(54) SYSTEM INCLUDING A VIRTUAL DISK

(76) Inventors: Yves Gattegno, L'Hay les Roses (FR); Philippe Auphelle, Chatillon (FR); Kevin Morris Carruthers, King of Prussia, PA (US)

(21) Appl. No.: 13/386,764

(22) PCT Filed: Sep. 21, 2009
(86) PCT No.: PCT/US09/57718

§ 371 Date: Jan. 24, 2012

(51) Int. Cl. G06F 15/167; G06F 9/00

(52) U.S. Cl. 713/2; 709/213

(57) ABSTRACT

A client configured to be connected and disconnected from a network includes: a memory storing a local mirrored copy of an image stored on a virtual disk server connected to the network; and a driver configured to access both the image stored on the virtual disk server and the local mirrored copy of the image when the client is connected to the network and to access only the local mirrored copy of the image when the client is disconnected from the network without requiring a reboot of the client after connecting or disconnecting from the network.

### BACKGROUND

One type of computing system utilizes streamed virtual disks where a client computer mounts a disk volume over a network. The disk volume is typically part of a virtual-disk server that can be used in place of a physical hard disk drive (HDD) locally attached to the client computer. The data that comprises the operating system (OS) and applications can be stored on the virtual disk server. To enable streamed virtual disks, a client computer is typically connected to a network having a bandwidth of at least 100 Mbps. A disruption in the network, either accidental (e.g., network failure) or deliberate (e.g., hibernate or disconnect client computer), breaks the connection to the virtual disk server and will result in loss of usability. To use a client computer off-line or when disconnected from the network, the client computer typically has to be rebooted using locally attached storage.

For these and other reasons, a need exists for the present invention.

### BRIEF DESCRIPTION OF THE DRAWINGS

FIG. 1 is a block diagram illustrating one embodiment of a system.

FIG. 2 is a block diagram illustrating one embodiment of a system including a client and a virtual disk server.

FIG. 3 is a functional block diagram illustrating one embodiment of a system.

FIG. 4 is a flow diagram illustrating one embodiment of a method for booting a client.

FIG. 5 is a flow diagram illustrating one embodiment of a method for performing a write operation.

FIG. 6 is a flow diagram illustrating one embodiment of a method for performing a read operation.

FIG. 7 is a block diagram illustrating another embodiment of a system including a client and a virtual disk server.

FIG. 8 is a flow diagram illustrating another embodiment of a method for performing a write operation.

FIG. 9 is a block diagram illustrating another embodiment of a system including a client and a virtual disk server.

FIG. 10 is a flow diagram illustrating one embodiment of a method for updating a client's local mirrored copy.

FIGS. 11A and 11B are a flow diagram illustrating another embodiment of a method for updating a client's local mirrored copy.

FIG. 12 is a flow diagram illustrating another embodiment of a method for updating a client's local mirrored copy.

### DETAILED DESCRIPTION

In the following detailed description, reference is made to the accompanying drawings which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

It is to be understood that the features of the various exemplary embodiments described herein may be combined with each other, unless specifically noted otherwise.

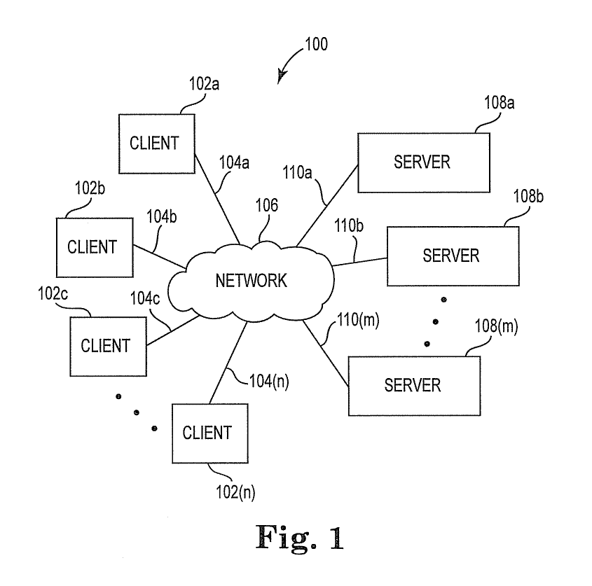

FIG. 1 is a block diagram illustrating one embodiment of a system 100. System 100 includes a plurality of clients 102a-102(n) (collectively referred to as clients 102), where “n” is any suitable number, a network 106, and a plurality of servers 108a-108(m) (collectively referred to as servers 108), where “m” is any suitable number. Each client 102a-102(n) is communicatively coupled to network 106 through a communication link 104a-104(n), respectively. Each server 108a-108(m) is also communicatively coupled to network 106 through a communication link 110a-110(m), respectively.

Each client 102 includes a computer or another suitable processing system or device capable of communicating over network 106 with a server 108. Network 106 includes any suitable number of interconnected switches, hubs, bridges, repeaters, routers, and/or other suitable network devices. Network 106 includes a local area network (LAN) or another suitable network. In one embodiment, network 106 has at least a 100 Mbps bandwidth. Each server 108 includes a virtual disk server or another suitable server.

In one embodiment, at least one client 102 is configured to access at least one streamed virtual disk from at least one server 108. In another embodiment, at least one client 102 is configured to access more than one streamed virtual disk from at least one server 108. In another embodiment, more than one client 102 is configured to access the same streamed virtual disk from at least one server 108. In another embodiment, at least one client 102 is configured to access streamed virtual disks from more than one server 108. In other embodiments, other suitable configurations are used.

System 100 provides an automated provisioning system for computers that is easy to use and available to a user that has skills to correctly administer a single computer. In system 100, when a client 102 is connected to network 106, the client can work from a streamed virtual disk stored on a server 108. A client 102 can be disconnected from network 106 and continue working from a mirrored copy of the streamed virtual disk, which is stored on the client. The disconnection from network 106 could be intentional or unintentional (e.g., cable failure, network failure, server failure). The client can be disconnected from network 106 and continue working from the mirrored copy without losing data and without disk service disruption. In addition, the client can be disconnected from network 106 and continue working from the mirrored copy without rebooting the client. In one embodiment, once the client is reconnected to network 106, the mirrored copy of the streamed virtual disk stored on the client is synchronized to the streamed virtual disk stored on the server.

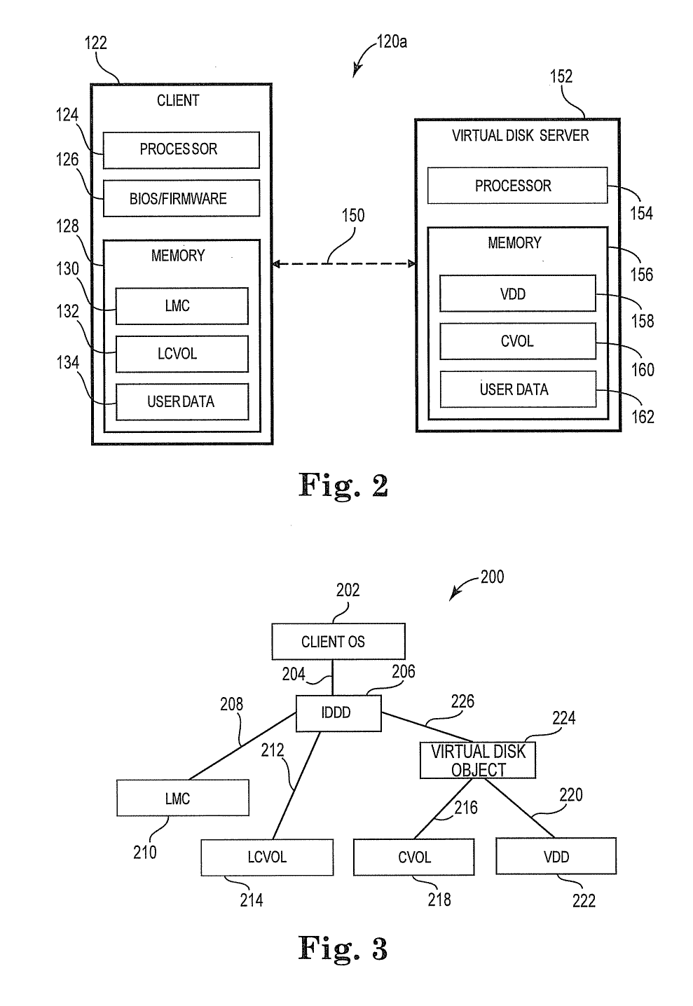

FIG. 2 is a block diagram illustrating one embodiment of a system 120a including a client 122 and a virtual disk server 152. In one embodiment, client 122 provides a client 102 and virtual disk server 152 provides a server 108 as previously described and illustrated with reference to FIG. 1. Client 122 includes a processor 124, bios/firmware 126, and memory 128. In one embodiment, memory 128 includes volatile (e.g., random access memory (RAM)) and/or non-volatile memory (e.g., hard disk drive (HDD)).

In the non-volatile memory, memory 128 stores a local mirrored copy (LMC) 130, a local client-volume-overlay (LCVOL) 132, and user data 134. LMC 130 and LCVOL 132 provide a local copy of a streamed virtual disk. Client 122 can be communicatively connected and disconnected to virtual disk server 152 through communication link 150. In one embodiment, communication link 150 is provided by a communication link 104, network 106, and a communication link 110 as previously described and illustrated with reference to FIG. 1.

Virtual disk server 152 includes a processor 154 and memory 156. In one embodiment, memory 156 includes volatile (e.g., RAM) and non-volatile memory (e.g., HDD). In the non-volatile memory, memory 156 stores a virtual disk drive (VDD) 158, a client-volume-overlay (CVOL) 160, and user data 162. VDD 158 and CVOL 160 provide a streamed virtual disk.

Processor 154 executes an operating system (OS) and applications on virtual disk server 152 for providing a streamed virtual disk to client 122. In one embodiment, VDD 158 stores an OS and applications to be executed by client 122. CVOL 160 stores sectors written to the streamed virtual disk by client 122. By using CVOL 160, more than one client can share VDD 158 at the same time by providing a separate CVOL for each client. In one embodiment, CVOL 160 is stored on a different server than the server that stores VDD 158.

During a write request by client 122, the sectors to be written are written to CVOL 160. During a read request by client 122, if the requested sectors were previously written, then the requested sectors are read from CVOL 160. If the requested sectors were not previously written, then the requested sectors are read from VDD 158. User data 162 stores data specific to a user, such as documents, favorites, preferences, etc. As such, a user can use any client and still access their own documents, favorites, preferences, etc.

Processor 124 executes an OS and applications on client 122. Bios/firmware 126 stores the code for booting client 122. LMC 130 stores a local copy of VDD 158. LMC 130 is initialized by building a mirrored image of VDD 158 in memory 128. After initialization, LMC 130 and VDD 158 contain the same set of data with the exception of customized data that are client specific, such as client computer name, domain security identification (SID)/domain credentials, etc. In one embodiment, the customized data are dynamically and transparently sent to each client. In one embodiment, the customized data is sent to each client based on each client's media access control (MAC) address, which provides an identifier that is linked to the customized data. In another embodiment, the customized data is sent to each client based on each client's unique ID such as a Universal Unique ID (UUID), which provides an identifier that is linked to the customized data.

LCVOL 132 stores a local copy of CVOL 160. In one embodiment with client 122 connected to virtual disk server 152, CVOL 160 and LCVOL 132 are erased when client 122 is shut down and/or when client 122 is booted or rebooted. In one embodiment with client 122 disconnected from virtual disk server 152, CVOL 160 and LCVOL 132 are maintained when client 122 is shut down and/or when client 122 is booted or rebooted. User data 134 stores a local copy of user data 162 and/or other user data.

With client 122 connected to virtual disk server 152 through communication link 150, processor 124 executes the OS and applications stored in VDD 158 and CVOL 160 (if existing). With client 122 connected to virtual disk server 152, client 122 boots using VDD 158 and CVOL 160 (if existing). The client OS then reads and writes sectors using a virtual disk driver as if it were reading and writing to a local disk drive, however, the read and write requests are actually translated into network packets and sent to virtual disk server 152. When virtual disk server 152 receives a read request from client 122, it reads the corresponding sectors and sends them to client 122 using network packets. The virtual disk driver in the client OS makes the data available to the client OS as if the data was read from a local disk drive.

With client 122 disconnected from virtual disk server 152, processor 124 executes the mirrored copy of the OS and applications stored in LMC 130 and LCVOL 132 (if existing). With client 122 disconnected from virtual disk server 152, client 122 boots using LMC 130 and LCVOL 132 (if existing). The client OS then reads and writes sectors using the virtual disk driver and the read and write requests are sent to LMC 130 and/or LCVOL 132.

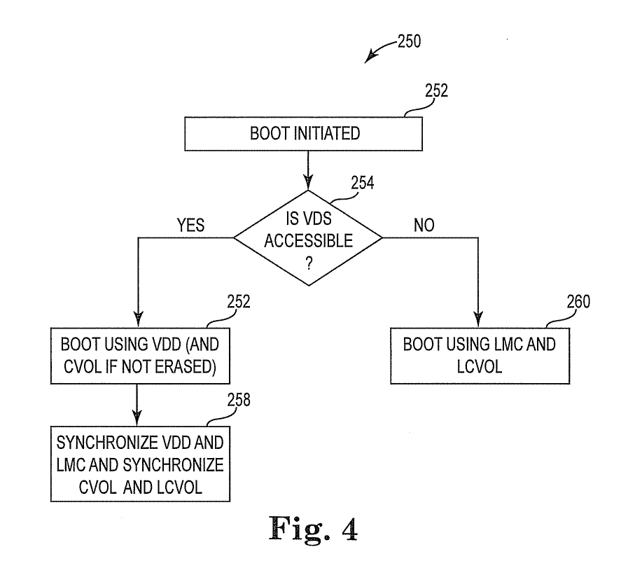

FIG. 3 is a functional block diagram illustrating one embodiment of a system 200. System 200 includes a client OS 202, an intermediate disk drive driver (IDDD) 206, a local mirrored copy (LMC) 210, a local client-volume-overlay (LCVOL) 214, a virtual disk object 224, a client-volume-overlay (CVOL) 218, and a virtual disk drive (VDD) 222. Client OS 202 is communicatively coupled to IDDD 206 through communication link 204. IDDD 206 is communicatively coupled to LMC 210 through communication link 208, to LCVOL 214 through communication link 212, and to virtual disk object 224 through communication link 226. Virtual disk object 224 is communicatively coupled to CVOL 218 through communication link 216 and to VDD 222 through communication link 220. In one embodiment, LMC 210 is provided by LMC 130, LCVOL 214 is provided by LCVOL 132, virtual disk object 224 is provided by virtual disk server 152, CVOL 218 is provided by CVOL 160, and VDD 222 is provided by VDD 158 as previously described and illustrated with reference to FIG. 2.

In one embodiment, processor 124 of client 122 executes client OS 202. IDDD 206 is a kernel driver that client OS 202 accesses as a raw disk drive (i.e., a block device). Client OS 202 communicates with IDDD 206 as though it were an actual physical disk drive. IDDD 206 performs read and write operations on the streamed virtual disk VDD 222 and CVOL 218 and/or on the local mirrored copy of the streamed virtual disk LMC 210 and LCVOL 214. In one embodiment, read operations are first sent to the local mirrored copy of the streamed virtual disk to decrease network load.

In one embodiment in response to a write operation, if the virtual disk server is accessible, then IDDD 206 writes the data to streamed virtual disk object 224 (which writes the corresponding data to CVOL 218) and the local mirrored copy of the streamed virtual disk (i.e., LCVOL 214). After both of the write operations to the streamed virtual disk and to the local mirrored copy of the streamed virtual disk have been acknowledged, IDDD 206 sends a write acknowledgement to client OS 202. If the write acknowledgement is not received by client OS 202 within a preset time, then the write operation is retried. In one embodiment, if one of the write operations was successful and one of the write operations failed, then only the write operation that failed is retried.

If the client does not include a local mirrored copy of the streamed virtual disk, IDDD 206 can still operate but the client cannot work off-line (i.e., when disconnected from the network). In this case, however, the write acknowledgement is sent to client OS 202 after the data is written to the streamed virtual disk object 224.

If the client does not have access to the virtual disk server (i.e., when the client is disconnected from the network), IDDD 206 can still operate as long as there is a local mirrored copy of the virtual disk object made up of LMC 210 and LCVOL 214. In this case, however, the write acknowledgement is sent to client OS 202 after the data is written to the local mirrored copy of the streamed virtual disk (i.e., LCVOL 214).

In one embodiment, both the streamed virtual disk and the local mirrored copy of the streamed virtual disk use logical block addressing (LBA) such that few or no translations have to be made to access a single sector. Sectors are accessed using the logical sector number (LSN). The first sector is LSN 0. In one embodiment, IDDD 206 maintains an internal list of the sectors that have been written locally since the client was booted. In one embodiment, the virtual disk server executes a virtual disk server program that maintains an internal list of the sectors that have been written since the client was booted. In one embodiment, these lists are journalized lists and embed the time each sector has been written to each media or the moment when the write acknowledgement was sent to client OS 202. In one embodiment, the times are used to apply the writes back in chronological order. In one embodiment, the write time on the server is returned with the write acknowledgement to the client and the client maintains the server time of the write when it receives the write acknowledgement.

In one embodiment, IDDD 206 considers the local mirrored copy of the streamed virtual disk as including at least two areas. One area is dedicated to LMC 210 and is typically used for read operations. The other area is dedicated to LCVOL 214, which contains the data that client OS 202 requests IDDD 206 to write. In one embodiment, LMC 210 and LCVOL 214 are two different files or two different sets of sectors on a local HDD, (e.g., two different partitions).

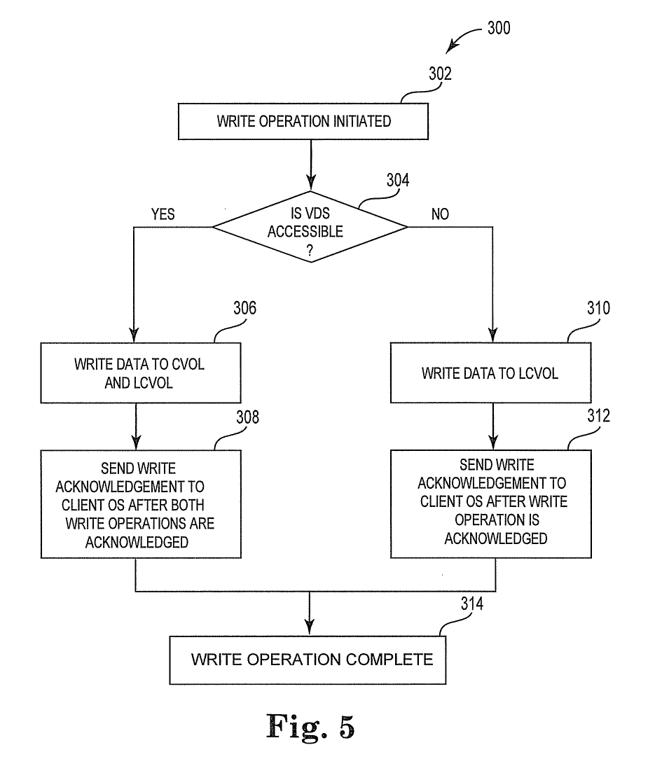

FIG. 4 is a flow diagram illustrating one embodiment of a method 250 for booting a client, such as client 122 previously described and illustrated with reference to FIG. 2. At 252, a boot is initiated. The boot can be initiated by a user turning on the client, by restarting the client, or by another suitable process. Upon initiating the boot of the client, the client bios/firmware is activated. At 254, the client determines whether the virtual disk server (VDS), such as virtual disk server 152 previously described and illustrated with reference to FIG. 2 is accessible. If the virtual disk server is accessible, then at 256 the client boots using VDD 158 and CVOL 160 (if CVOL is not erased). In one embodiment, CVOL 160 and LCVOL 132 are erased when client 122 boots using VDD 158. At 258, the client synchronizes VDD 158 with LMC 130 and CVOL 160 with LCVOL 132. If the virtual disk server is not accessible, then at 260 the client boots using LMC 130 and LCVOL 132.

In one embodiment when booting using LMC 130 and LCVOL 132, a standard boot loader can be used if LMC 130 is the active partition of an x86 computer, if LCVOL 132 does not contain any data to be read before IDDD 206 takes control (i.e., during the real-mode portions of the boot process), and if there are no write operations occurring before IDDD 206 takes control or such write operations can be discarded or retried after booting. In another embodiment, a standard boot loader is used where the local storage is divided into three or more parts. The first part (PART1) is the active partition that a client will boot off when used normally. The second and third parts are LMC 130 and LCVOL 132. PART1 exposes the standard boot loaders (e.g., BIOS plus master boot record (MBR)) to a partition containing a standard OS up to the moment when IDDD 206 can take control. IDDD 206 and/or other components in client OS 202 record in PART1 what is needed for the standard boot process using a standard boot loader to be able to load and initialize.

In one embodiment, PART1 contains a complete and comprehensive partition containing the equivalent of LMC 130 plus LCVOL 132. In this case, for each write request of a specific sector, IDDD 206 performs two write operations on the local storage: once in PART1 and once in LCVOL 132. The write operations are acknowledged after both sectors have been written. In another embodiment, PART1 contains just enough information to allow the client OS to load and initialize from local storage up to the moment when IDDD 206 can take control. For example, for a Windows XP client OS, just enough is NTLDR, NTDETECT.COM, boot.ini, the SYSTEM registry hive (typically C:\WINDOWS\SYSTEM32\CONFIG\SYSTEM), HAL. DLL, NTOSKRNL.EXE, each driver loaded at boot time (i.e., boot drivers), and the files that they depend on. In this case, a process keeps PART1 consistent and compatible with the standard boot process. In one embodiment, in the case of a Windows XP client OS, the process updates the SYSTEM registry hive at least once for each session and also analyzes the set of boot drivers by exploring the registry to make sure that the files used to load and initialize them are present in PART1.

In another embodiment, a non-standard boot program is used. In this case, the boot program can reside in bios/firmware 126 or be loaded as a master boot record (MBR) or a volume boot record (VBR). The boot program interfaces with the local storage components to reassemble them dynamically into a complete image. This is done for each request. The boot program uses a unique identification (ID) of the end state of the device (i.e., the ID representing the combination of a base volume plus CVOL1 plus CVOL(n)). These volumes are searched sequentially backwards for each sector until the driver loads and captures the volume sector indexes into memory data structures.

The ID of a volume would typically be constructed the following way: a prefix made of a GUID identifying in a unique manner the disk drive and a postfix comprising a revision number and a date of revision. This makes any comparison of IDs able to determine that we do compare two revisions of the same disk and that one of them is previous to the other. Each layer (Volume Image file, intermediate overlays, top-most overlays) also has a unique identifier. Furthermore, each layer that is a delta to an underlying layer has a way to identify its “father”: it records in its metadata the ID of its father. The resulting of these ID structures is the following: each “logical volume” that can be accessed in a tree of layer shares the same “disk identifier” but has a “unique revision number” and each layer in a tree of layers, but the root which is the volume image file itself embeds the ID of its father.

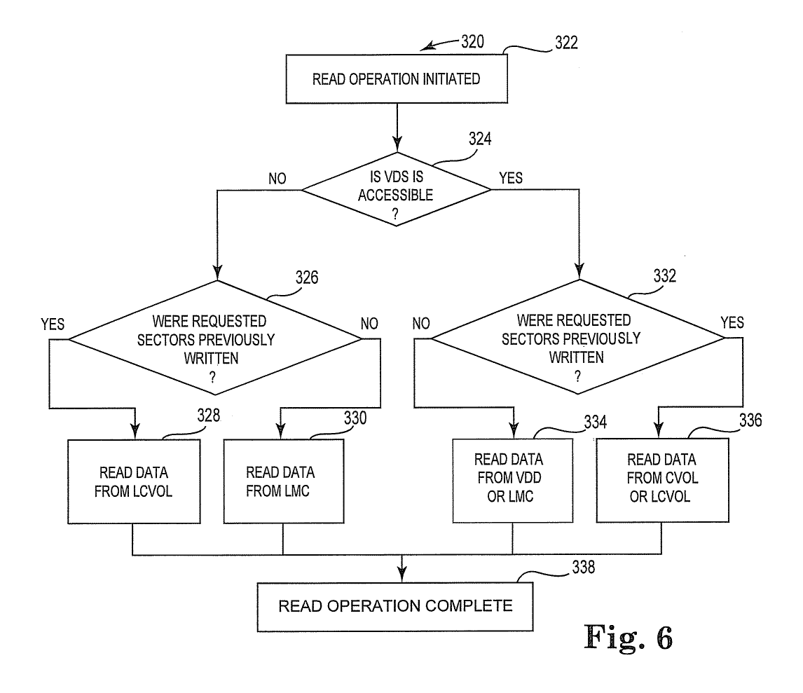

FIG. 5 is a flow diagram illustrating one embodiment of a method 300 for performing a write operation. At 302, client OS 202 initiates a write operation. At 304, IDDD 206 determines whether virtual disk server 152 is accessible. If virtual disk server 152 is accessible, then at 306 IDDD 206 writes the data to CVOL 218 and LCVOL 214. At 308, IDDD 206 sends a write acknowledgement to client OS 202 after the write operations to CVOL 218 and LCVOL 214 are acknowledged (i.e., data are actually written). If virtual disk server 152 is not accessible, then at 310 IDDD 206 writes the data to LCVOL 214. At 312, IDDD 206 sends a write acknowledgement to client OS 202 after the write operation to LCVOL 214 is acknowledged. At 314, the write operation is complete.

When client 122 is disconnected and then gets reconnected to virtual disk server 152, IDDD 206 detects the reconnection. Upon detecting the reconnection, IDDD 206 synchronizes LCVOL 214 and CVOL 218 so that CVOL 218 contains a copy of the data in LCVOL 214. In one embodiment, IDDD 206 uses journalized lists for LCVOL 214 sectors and virtual disk server 152 uses journalized lists for CVOL 218 sectors. In this case, only the sectors that are not present or not the same in LCVOL 214 and CVOL 218 are copied from client 122 to virtual disk server 152, thus minimizing the time for resynchronization.

Resynchronization of LCVOL 214 and CVOL 218, however, is only needed when it is desired to have redundant storage as often as possible since IDDD 206 can work independently from virtual disk server 152. Client 122 can continue working using LMC 210 and LCVOL 214 even if client 122 is reconnected to virtual disk server 152. In this case, when the user logs off, the user's roaming profile (if any) and data are then synchronized onto the roaming profiles and personal data servers. The next time client 122 is rebooted when connected to virtual disk server 152, IDDD 206 uses VDD 222.

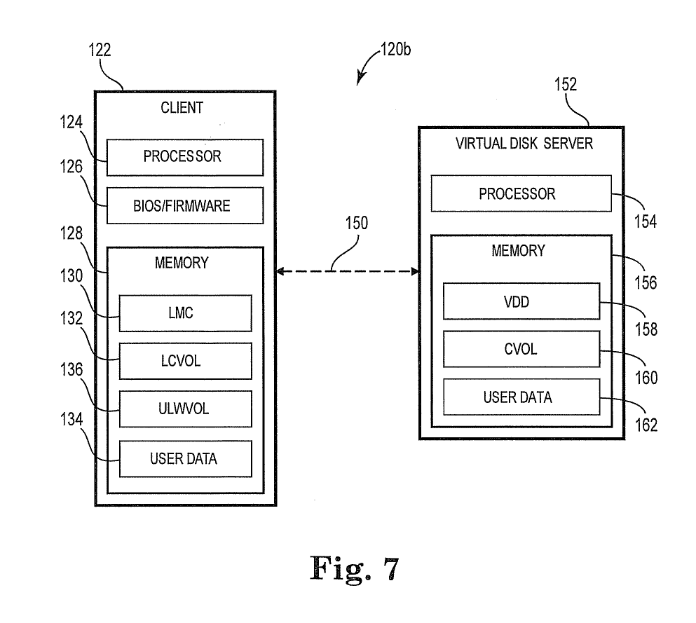

FIG. 6 is a flow diagram illustrating one embodiment of a method 320 for performing a read operation. At 322, client OS 202 initiates a read operation. At 324, IDDD 206 determines whether virtual disk server 152 is accessible. If virtual disk server 152 is not accessible, then at 326 IDDD 206 determines whether the requested sectors were previously written to LCVOL 214. If the sectors were previously written to LCVOL 214, then at 328 the data is read from LCVOL 214. If the sectors were not previously written to LCVOL 214, then at 330 the data is read from LMC 210.

If virtual disk server 152 is accessible, then at 332 IDDD 206 determines whether the requested sectors were previously written to LCVOL 214 and/or CVOL 218. If the sectors were not previously written to LCVOL 214 and/or CVOL 218, then at 334 the data is read from VDD 222 or LMC 210. If the sectors were previously written to LCVOL 214 and/or CVOL 218, then at 336 the data is read from CVOL 218 or LCVOL 214. At 338, the read operation is complete.

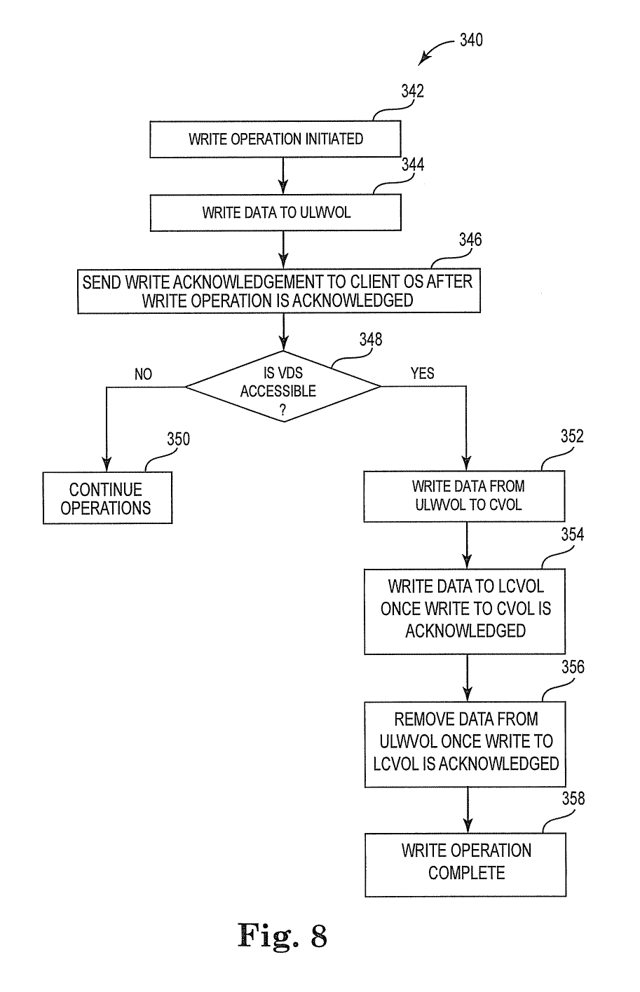

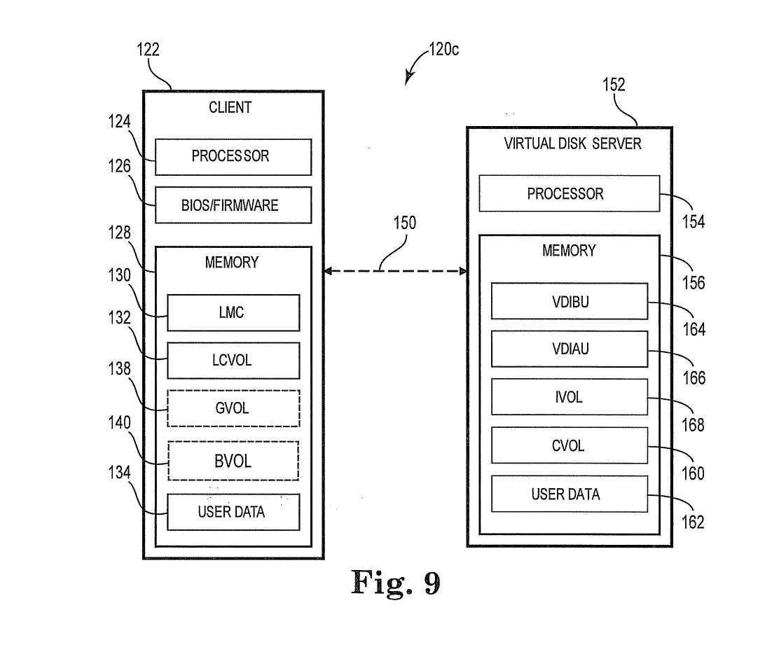

FIG. 7 is a block diagram illustrating another embodiment of a system 120b including a client 122 and a virtual disk server 152. System 120b is similar to system 120a previously described and illustrated with reference to FIG. 2, except that in system 120b, memory 128 of client 122 stores an unacknowledged local write volume (ULWVOL) 136. ULWVOL 136 is a separate incremental LCVOL that is persistent to the local storage but is separate and distinct from LCVOL 132. ULWVOL 136 operates within system 120b similar to LCVOL 132 and is used for write operations as described below with reference to FIG. 8.

FIG. 8 is a flow diagram illustrating another embodiment of a method 340 for performing a write operation. At 342, client OS 202 initiates a write operation. At 344, IDDD 206 writes the data to ULWVOL 136. At 348, IDDD 206 determines whether virtual disk server 152 is accessible. If virtual disk server 152 is not accessible, then at 350 client OS 202 continues by performing read operations on LMC 130, LCVOL 132, or ULWVOL 136 (depending on where the requested sectors were last written) and by performing write operations to ULWVOL 136.

If at 348 virtual disk server 152 is accessible or when virtual disk server 152 becomes accessible during 350, then at 352 IDDD 206 writes the data from ULWVOL 136 to CVOL 160. At 354, IDDD 206 writes the data to LCVOL 132 once the write to CVOL 160 is acknowledged. At 356, IDDD 206 removes the data from ULWVOL 136 once the write to LCVOL 132 is acknowledged. At 358, the write operation is complete and LCVOL 132 is a copy of CVOL 160. By using ULWVOL 136, symmetric journalized lists for sector writes on both client 122 and virtual disk server 152 are not needed.

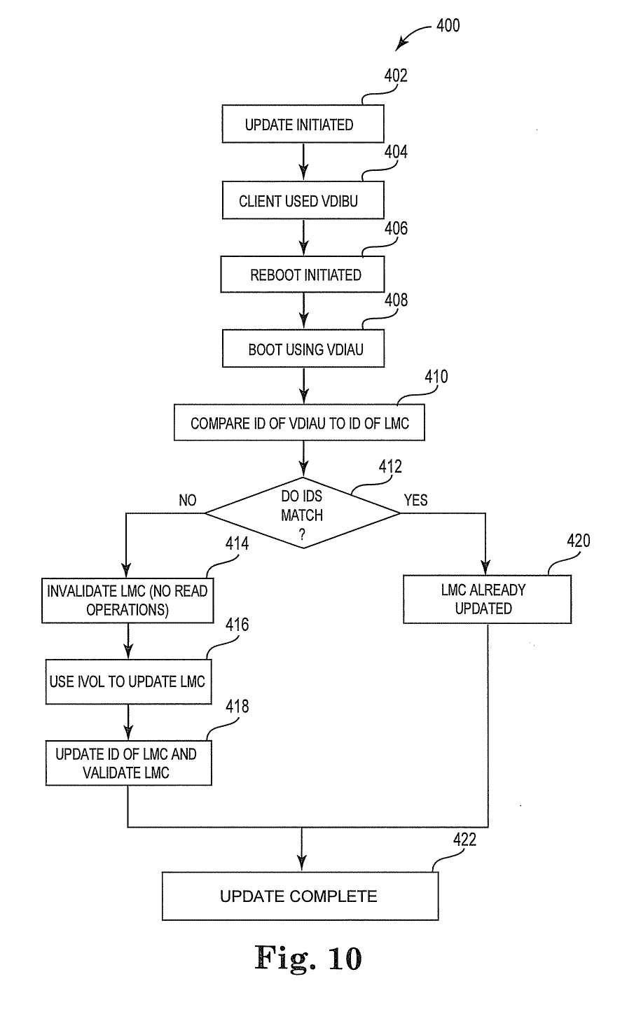

FIG. 9 is a block diagram illustrating another embodiment of a system 120c including a client 122 and a virtual disk server 152. System 120c is similar to system 120a previously described and illustrated with reference to FIG. 2, except that in system 120c, memory 128 of client 122 stores a ghost volume (GVOL) 138 and memory 156 of virtual disk server 152 stores a virtual disk image before upgrade (VDIBU) 164, a virtual disk image after upgrade (VDIAU) 166, and an image volume overlay (IVOL) 168. In one embodiment, memory 128 of client 122 also stores a backup volume overlay (BVOL) 140.

GVOL 138, BVOL 140, VDIBU 164, VDIAU 166, and IVOL 168 are used to update LMC 130. When an administrator updates an existing virtual disk image, the current virtual disk image is kept as VDIBU 164 and the modifications to VDIBU 164 are recorded on the server side in IVOL 168. In one embodiment, IVOL 168 has a similar structure to CVOL 160. In one embodiment, modifications to the virtual disk image are a list of sectors and corresponding sector data. VDIBU 164 has a unique identifier, VDIAU 166 has a unique identifier that differs from VDIBU's identifier, and IVOL also has a unique identifier. The identifier identifies the logical disk comprised of VDIBU 164 plus IVOL 168. In one embodiment, IVOL 168 is first created as a CVOL since the modifications are made to the virtual disk image by a single client. For example, an administrator may apply patches to the OS in VDIBU 164. The CVOL is then made IVOL 168 by the administrator. Thus, the clients that mount the updated virtual disk will mount the result of VDIBU 164 plus IVOL 168.

For example, at time to, several clients use VDIBU 164. Each of the clients has a copy of VDIBU 164 as LMC 130. At time t1>t0, the administrator updates VDIBU 164 and creates IVOL 168. The administrator then configures virtual disk server 152 such that the clients that used VDIBU 164 will now mount VDIAU 166 (i.e., VDIBU+IVOL) the next time they boot.

GVOL 138 is used for updating LMC 130. GVOL 138 is a CVOL with an additional property per-sector indicating whether the data is present or not. GVOL 138 is used to force read operations to be redirected to virtual disk server 152. Once data is read from virtual disk server 152, the data is stored in GVOL 138 and marked as present. Once GVOL 138 is fully populated, LMC 130 is updated using GVOL 138.

In one embodiment, BVOL 140 is used during the updating of LMC 130. BVOL 140 enables recovery of the previous state of LMC 130 if a problem occurs during the updating of LMC 130. BVOL 140 is updated with the data from LMC 130 before the data in LMC 130 is replaced by the corresponding data from GVOL 138. Once all the data from GVOL 138 has replaced the corresponding data in LMC 130, BVOL 140 is invalidated (i.e., removed or erased). Therefore, if the updating of LMC 130 using GVOL 138 is interrupted before completing, BVOL 140 can be used to recover the previous state of LMC 130. In one embodiment, this recovery of LMC 130 occurs at the next reboot of client 122.

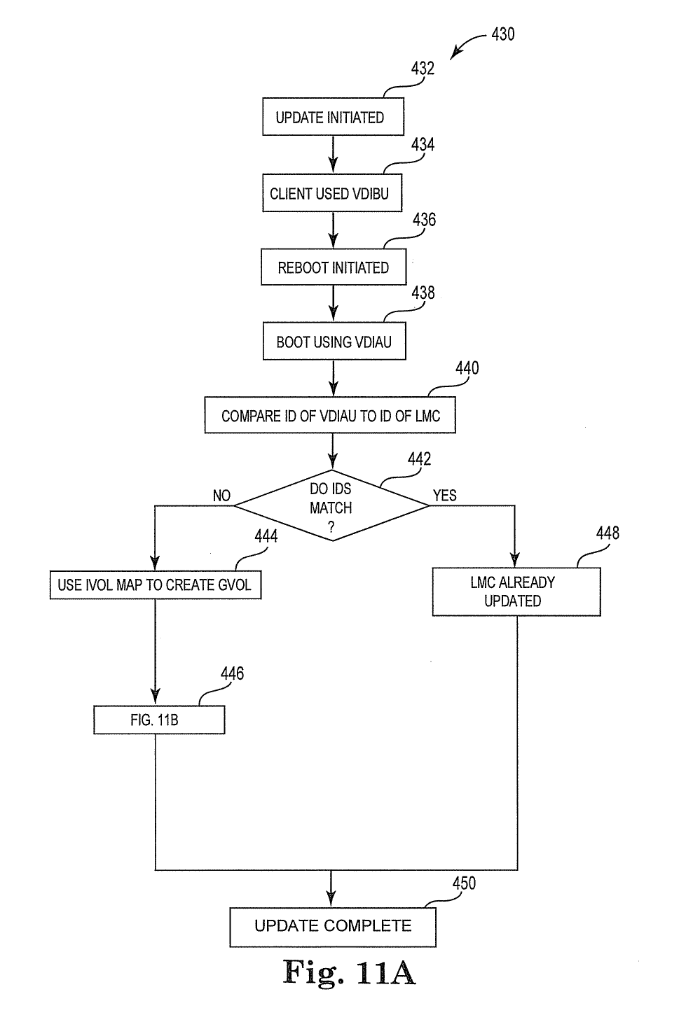

FIG. 10 is a flow diagram illustrating one embodiment of a method 400 for updating a client's LMC 130. At 402, an administrator initiates an update by creating VDIAU 166 and IVOL 168. At 404, client 122 is currently using VDIBU 164 and continues to use VDIBU 164 until the client is rebooted. At 406, a reboot of client 122 is initiated. At 408, client 122 boots using VDIAU 166. At 410, client 122 compares the identifier of VDIAU 166 to the identifier of LMC 130. At 412, if the identifier of VDIAU 166 matches the identifier of LMC 130, then at 420 LMC 130 has already been updated and the update is complete at 422.

If the identifier of VDIAU 166 does not match the identifier of LMC 130, then at 414, LMC 130 is invalidated. With LMC 130 invalidated, read operations cannot be directed to LMC 130. In this case, the client then operates using VDIAU 166 of virtual disk server 152. At 416, IVOL 168 is used to update LMC 130 by updating the sectors in LMC 130 as indicated by IVOL 168. At 418, the identifier of LMC 130 is updated to match the identifier of VDIAU 166 and LMC 130 is validated. With LMC 130 validated, read operations may again be directed to LMC 130. At 422, the update of LMC 130 is complete.

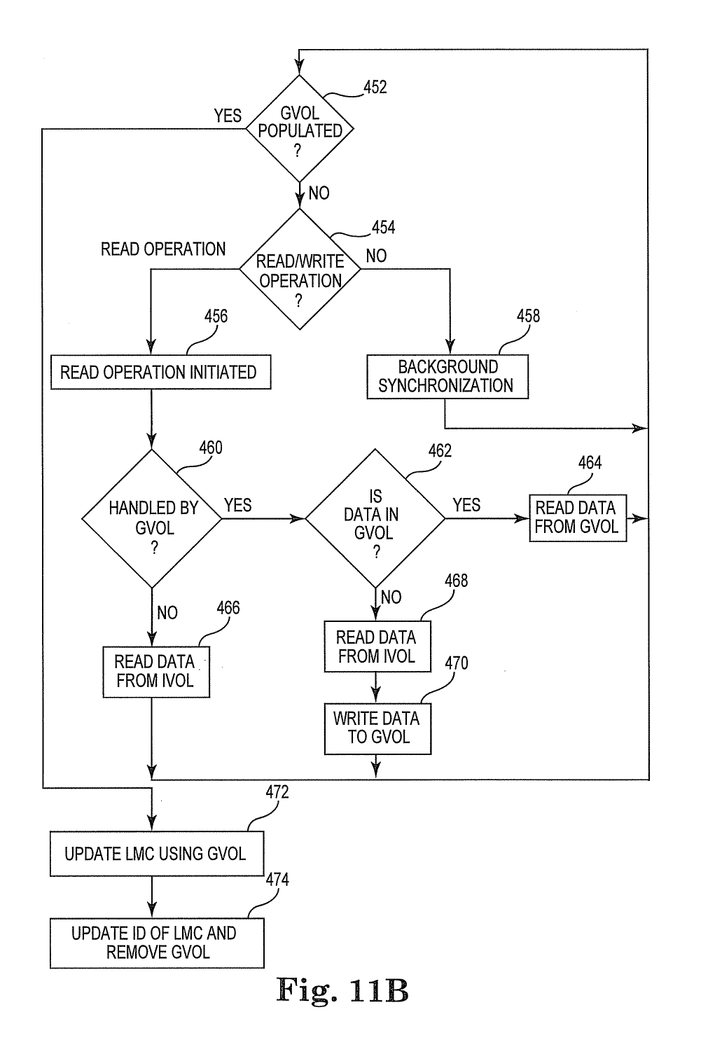

FIGS. 11A and 11B are a flow diagram illustrating another embodiment of a method 430 for updating a client's LMC 130. At 432, an administrator initiates an update by creating VDIAU 166 and IVOL 168. At 434, client 122 is currently using VDIBU 164 and continues to use VDIBU 164 until the client is rebooted. At 436, a reboot of client 122 is initiated. At 438, client 122 boots using VDIAU 166. At 440, client 122 compares the identifier of VDIAU 166 to the identifier of LMC 130. At 442, if the identifier of VDIAU 166 matches the identifier of LMC 130, then at 448 LMC 130 has already been updated and the update is complete at 450.

If the identifier of VDIAU 166 does not match the identifier of LMC 130, then at 444 the IVOL map is used to create GVOL 138. In one embodiment, the IVOL map includes a list of sectors. Initially, GVOL 138 is created using the list of sectors but none of the corresponding data is present. As such, the data for each sector in GVOL 138 is indicated as not present. At 446, the flow diagram continues in FIG. 11B.

At 452, if GVOL is not fully populated, flow continues to block 454. At block 454, if no read or write operations are occurring, then at 458 background synchronization is performed. Background synchronization copies data (e.g., a set of sectors) from IVOL 168, which is not yet present in GVOL 138, and stores the data in GVOL 138 and marks the corresponding sector as present. Flow then returns to block 452. If a read operation is requested at block 454, then at 456 a read operation is initiated. At 460, if the requested data is not handled by GVOL 138, then the requested data is read from IVOL 168 at 466. Flow then returns to block 452.

At 460, if the requested data is handled by GVOL 138 and the data is already stored in GVOL 138 at 462, then at 464 the data is read from GVOL 138. Flow then returns to block 452. If the requested data is handled by GVOL 138 and the data is not already stored in GVOL 138 at 462, then at 468 the data is read from IVOL 168. At 470, the read data is written to GVOL 138 and marked as present in GVOL 138. Flow then returns to block 452. If at 452 GVOL 138 is fully populated, then at 472 LMC 130 is updated using GVOL 138. In one embodiment, BVOL 140 is used to store a copy of LMC 130 for recovering LMC 130 if the update of LMC 130 using GVOL 138 fails (e.g., a power outage during the update). At 474, the ID of LMC 130 is updated to match the identifier of VDIAU 166 and GVOL 138 is removed. Returning to FIG. 11A, the update of LMC 130 is complete at 450.

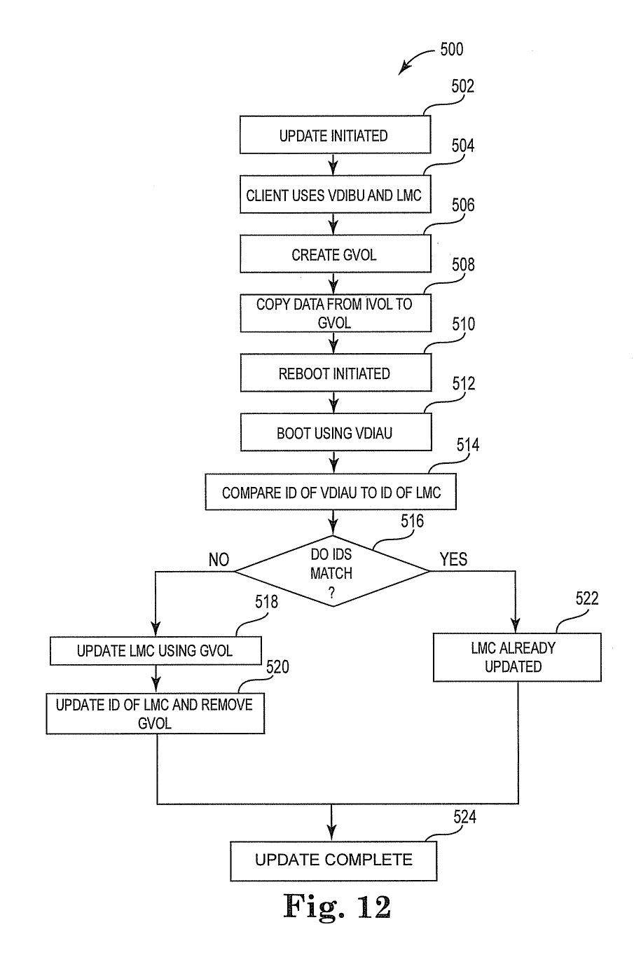

FIG. 12 is a flow diagram illustrating another embodiment of a method 500 for updating a client's LMC 130. At 502, an administrator initiates an update by creating VDIAU 166 and IVOL 168. At 504, the client is currently using VDIBU 166 and LMC 130. At 506, the client creates GVOL 138 based on the IVOL map. At 508, in parallel with any read operations, the client copies the data from IVOL 168 to GVOL 138. In one embodiment, this is a background process where network idle time is detected and used to request sectors. In another embodiment, virtual disk server 152 decides when to transmit the sectors to GVOL 138. Since GVOL 138 is not needed for system operation, the sectors can be transmitted to client 122 asynchronously when the server is lightly loaded. In another embodiment, virtual disk server 152 propagates the sectors, but uses multi-cast to deliver the sectors into the GVOLs of multiple devices simultaneously. Since the data contained in GVOLs is not performance sensitive, more complex or reliable communication protocols may be used (i.e., TCP instead of UDP).

Once all the data from IVOL 168 is copied to GVOL 138, LMC 130 may be updated after the next client reboot. At 510, a reboot of client 122 is initiated. At 512, client 122 boots using VDIAU 166. At 514, client 122 compares the identifier of VDIAU 166 to the identifier of LMC 130. At 516, if the identifier of VDIAU 166 matches the identifier of LMC 130, then at 522 LMC 130 has already been updated and the update is complete at 524.

If the identifier of VDIAU 166 does not match the identifier of LMC 130, then at 518 LMC 130 is updated using GVOL 138 by updating the sectors in LMC 130 as indicated by GVOL 138. At 520, the identifier of LMC 130 is updated to match the identifier of VDIAU 166 and GVOL 138 is removed. At 524, the update of LMC 130 is complete. Using GVOL 138 preserves the integrity of LMC 130 until the synchronization is complete. If the client's connection to the virtual disk server fails or is interrupted during the synchronization period (i.e., while GVOL 138 is being populated), the client can recover by rebooting.

CVOL 160 and LCVOL 132 contain deltas to the disk (i.e., sectors that have been written and that may then be different than the corresponding sectors in the disk). If the disk itself has changed, the sets VDD+CVOL and LMC+LCVOL are meaningful only if CVOL refers to the actual VDD or if LCVOL refers to the actual LMC. That is, if a CVOL exists and the corresponding VDD is updated, then the CVOL has to be discarded or emptied. The same thing happens when a LCVOL exists and the corresponding LMC is updated. Therefore, prior to the LMC update process, any LCVOL has to be discarded or emptied (or merged if relevant).

In one embodiment, client 122 sends to virtual disk server 152 the unique identity of the client's LMC so that the server is aware if any client has not yet been updated. When all the clients have updated their LMCs and none of them are using an LMC of VDIBU, VDIBU is merged with IVOL (i.e., all the sectors in IVOL replace the corresponding sectors in VDIBU thus creating an independent single image file). VDIBU can then be destroyed. In another embodiment, VDD is only used when the data in LMC and VDD are not the same.

Embodiments provide a system for easily provisioning computers without having to build packages or learning how to use complex software applications. Embodiments of the system also provide inexpensive redundant storage for desktops and laptop computers. For example, if the HDD of a client computer fails, a new blank HDD can be prepared for the client computer. Once the client computer with the new HDD is connected to the network, the client computer is automatically provisioned and kept up-to-date.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A client configured to be connected and disconnected from a network, the client comprising:
a memory storing a local mirrored copy of an image stored on a virtual disk server connected to the network; and
a driver configured to access both the image stored on the virtual disk server and the local mirrored copy of the image when the client is connected to the network and to access only the local mirrored copy of the image when the client is disconnected from the network without requiring a reboot of the client after connecting or disconnecting from the network.

2. The client of claim 1, wherein the virtual disk server stores a client volume overlay, and
wherein the memory stores a local client volume overlay.

3. The client of claim 2, wherein the driver is configured to send written data to the local client volume overlay and to the client volume overlay stored on the virtual disk server when the client is connected to the network.

4. The client of claim 2, wherein the memory stores an unacknowledged local write volume configured to store write data, and
wherein the driver is configured to update the client volume overlay stored on the virtual disk server with the write data stored in the unacknowledged local write volume, update the local client volume overlay with the write data after the client volume overlay stored on the virtual disk server is updated, and remove the write data from the unacknowledged local write volume after the local client volume overlay is updated.

5. The client of claim 1, wherein the client is configured to boot up using the image stored on the virtual disk server when the client is connected to the network and to boot up using the local mirrored copy of the image when the client is disconnected from the network.

6. The client of claim 5, wherein the client is configured to synchronize the local mirrored copy of the image to the image stored on the virtual disk server when the client boots up off the virtual disk server.

7. The client of claim 1, wherein the virtual disk server stores an image volume overlay indicating changes to the image stored on the virtual disk server in response to an update to the image stored on the virtual disk server, and
wherein the client generates a ghost volume on the local disk drive based on the image volume overlay, populates the ghost volume with data from the image volume overlay, copies the data in the ghost volume to the local mirrored copy of the image once the ghost volume is fully populated, and removes the ghost volume once all the data from the ghost volume is copied to the local mirrored copy of the image.

8. A system comprising:
a virtual disk image accessible over a network; and
a device configured to be connected and disconnected from the network, the device comprising:
means for storing a local mirrored copy of the virtual disk image; and
means for accessing both the virtual disk image accessible over the network and the local mirrored copy of the virtual disk image when the device is connected to the network and for accessing the local mirrored copy of the virtual disk image when the device is disconnected from the network without requiring a reboot of the device after connecting or disconnecting from the network.

9. A method for accessing a virtual disk image, the method comprising:
copying a virtual disk image stored on a network connected device to a local storage device of a client when the client is initially connected to the network to provide a local mirrored copy of the image;
accessing both the virtual disk image and the local mirrored copy of the image when the client is connected to the network; and
accessing only the local mirrored copy of the image when the client is disconnected from the network without requiring a reboot of the client after connecting or disconnecting the client from the network.

10. The method of claim 9, further comprising:
maintaining a client volume overlay on the network connected device; and
maintaining a local client volume overlay on the client.

11. The method of claim 10, further comprising:
synchronizing the local client volume overlay and the client volume overlay stored on the network connected device when the client is connected to the network.

12. The method of claim 10, further comprising:
maintaining an unacknowledged local write volume on the client to store pending write data;
updating the client volume overlay stored on the network connected device with the pending write data stored in the unacknowledged local write volume;
updating the local client volume overlay with the pending write data after the client volume overlay stored on the network connected device is updated; and
removing the pending write data from the unacknowledged local write volume after the local client volume overlay is updated.

13. The method of claim 9, further comprising:
booting up the client off the network connected device when the client is connected to the network; and
booting up the client off the local storage device when the client is disconnected from the network.

14. The method of claim 13, further comprising:
synchronizing the local mirrored copy of the image to the image stored on the network connected device when the client boots up off the network connected device.

15. The method of claim 9, further comprising:
storing an image volume overlay indicating changes to the image stored on the network connected device in response to an update to the image stored on the network connected device;
generating a ghost volume on the local storage device based on the image volume overlay;
populating the ghost volume with data from the image volume overlay;
copying the data in the ghost volume to the local mirrored copy of the image once the ghost volume is fully populated; and
removing the ghost volume once all the data from the ghost volume is copied to the local mirrored copy of the image.
